(19) United States
(12) Patent Application Publication
(10) Pub. No.: US 2022/0361475 A1
(43) Pub. Date: Nov. 17, 2022

(54) SYSTEM AND METHOD FOR MAINTENANCE OF WAY

(71) Applicant: Transportation IP Holdings, LLC, Norwalk, CT (US)

(72) Inventors: Mark Bachman, Albia, IA (US); Michael VanderLinden, Knoxville, IA (US); Norman Wellings, Agency, IA (US); Mark Kraeling, Melbourne, FL (US)

(21) Appl. No.: 17/815,341

(22) Filed: Jul. 27, 2022

Related U.S. Application Data
(63) Continuation-in-part of application No. 17/461,930, filed on Aug. 30, 2021.
(60) Provisional application No. 63/072,586, filed on Aug. 31, 2020.

(51) Int. Cl. A01M 21/04; G06V 20/10; G06V 20/56; G06V 10/82; G06T 7/00; G06T 7/73

(52) U.S. Cl. CPC A01M 21/046; G06V 20/188; G06V 20/56; G06V 10/82; G06T 7/0012; G06T 7/73; G06T 2207/20081; G06T 2207/20084; G06T 2207/30188; G06T 2207/30252

(57) ABSTRACT

A system may include an imaging device to obtain image data from a field of view outside of a vehicle. A controller may analyze the image data and identify one or more vegetation features of a target vegetation within the field of view. The vegetation features may be a type, a quantity, a distance, and/or a size of vegetation. A directed energy system may direct one or more directed energy beams toward the target vegetation responsive to the controller identifying the one or more vegetation features. A method may include analyzing image data from a field of view adjacent to a vehicle and determining one or more vegetation features of target vegetation within the field of view to be removed. The method may include directing a directed energy beam(s) onto the target vegetation. The directed energy beam(s) may be controlled based in part on the one or more vegetation features.

### CROSS-REFERENCE TO RELATED APPLICATIONS

This application is a continuation-in-part of U.S. application Ser. No. 17/461,930, filed on 30 Aug. 2021, which claims priority to U.S. application Ser. No. 63/072,586, filed on 31 Aug. 2020, the entire disclosure of each being incorporated herein by reference.

### BACKGROUND

### Technical Field

Embodiments of the subject matter disclosed herein relate to systems for maintenance of way and associated methods.

### Discussion Of Art

Vegetation growth is a dynamic aspect for routes such as paths, tracks, roads, etc. Over time, vegetation may grow in such a way as to interfere with travel over the route and must be managed. Vegetation management may be time and labor intensive. For both in-vehicle and wayside camera systems, these camera systems may capture information relating to the state of vegetation relative to a route, but that information is not actionable.

It may be desirable to have a system and method for vegetation control that differs from those that are currently available.

### BRIEF DESCRIPTION

According to one example or aspect, a system may include an imaging device to obtain image data from a field of view outside of a vehicle and a controller to analyze the image data and identify one or more vegetation features of a target vegetation within the field of view. The vegetation features may be one or more of a type of vegetation, a quantity of vegetation, a distance or a size of vegetation. The system may include a directed energy system to direct one or more directed energy beams toward the target vegetation responsive to the controller identifying the one or more vegetation features.

According to one example or aspect, a method may include analyzing image data from a field of view adjacent to a vehicle and determining one or more vegetation features of target vegetation within the field of view to be removed. The method may include directing one or more directed energy beams onto the target vegetation, and the one or more directed energy beams are controlled based at least in part on the one or more vegetation features.

According to one example or aspect, a system may include one or more imaging devices onboard one or more vehicles to obtain image data from one or more fields of view adjacent to the one or more vehicles and one or more controllers in communication with the one or more imaging devices to analyze the image data and determine one or more vegetation features of target vegetation within the one or more fields of view. The system may include one or more directed energy systems onboard the one or more vehicles to generate and direct one or more energy beams onto the target generation in response to the controller analysis of the vegetation features.

### BRIEF DESCRIPTION OF THE DRAWINGS

The subject matter described herein will be better understood from reading the following description of non-limiting embodiments, with reference to the attached drawings, wherein below:

FIG. 1 schematically illustrates a portable system for capturing and communicating transportation data related to vehicle systems or otherwise to a transportation system according to one embodiment;

FIG. 2 schematically illustrates an environmental information capture system according to one embodiment;

FIG. 3 schematically illustrates a camera system according to one embodiment;

FIG. 4 schematically illustrates a camera system according to one embodiment;

FIG. 5 schematically illustrates a camera system according to one embodiment;

FIG. 6 schematically illustrates a vehicle system according to one embodiment;

FIG. 7 schematically illustrates a vehicle system according to one embodiment;

FIG. 8 schematically illustrates a vehicle system according to one embodiment;

FIG. 9 schematically illustrates a camera system according to one embodiment;

FIG. 10 illustrates another embodiment of an inventive system;

FIG. 11 schematically illustrates an environmental information acquisition system according to one embodiment;

FIG. 12 schematically illustrates a side view of the system shown in FIG. 11;

FIG. 13 schematically illustrates a top view of the system shown in FIG. 11;

FIG. 14 schematically illustrates an image analysis system according to one embodiment;

FIG. 15 schematically illustrates a method according to one embodiment;

FIG. 16 schematically illustrates a vehicle system according to one embodiment;

FIG. 17 schematically illustrates a maintenance of way system according to one embodiment;

FIG. 18 schematically illustrates a directed energy system according to one embodiment;

FIG. 19 schematically illustrates a machine learning model according to one embodiment; and

FIG. 20 schematically illustrates a method according to one embodiment.

### DETAILED DESCRIPTION

Embodiments described herein relate to a system for vegetation control, maintenance of way along a route, vehicular transport therefore, and associated methods. In one embodiment, a vegetation control system is provided that includes a directed energy system onboard one or more vehicles of a vehicle system and one or more controllers that may operate the vehicle system and/or the directed energy system based at least in part on environmental information.

The one or more controllers may communicate with a position device that may provide location information. Location information may include position data on the vehicle system, as well as the vehicle system speed, data on the route over which the vehicle system will travel, and various areas relating to the route. Non-vehicle information may include whether the vehicle system is in a populated area, such as a city, or in the country. Non-vehicle information may indicate whether the vehicle system is on a bridge, in a draw, in a tunnel, or on a ridge. Non-vehicle information may indicate whether the route is following along the bank of a river or an agricultural area. Additional information may include which side of the vehicle system which of these features is on. The one or more controllers may actuate the directed energy system based at least in part on position data obtained by the controller from the position device. During use, the one or more controllers may prevent the directed energy system from emitting one or more directed energy beams while in a tunnel or near a structure or near people. As detailed herein, the one or more controllers may control such directed energy beam factors as the duration, power, angle, and emission pattern in response to vegetation being higher, lower, nearer, or farther away from the vehicle system.

Regarding environmental information, this is information that the one or more controllers may use that could affect the application of the one or more directed energy beams. Suitable sensors may collect and communicate the environmental information to the one or more controllers. Environmental information may include one or more of a traveling speed of the vehicle system, an operating condition of the directed energy system, a power level of the directed energy system, a type of vegetation, a quantity of vegetation, a terrain feature of a route section adjacent to the laser system, an ambient humidity level, an ambient temperature level, a direction of travel of the vehicle, curve or grade information of the vehicle route, a direction of travel of wind adjacent to the vehicle, a windspeed of air adjacent to the vehicle, a distance of the vehicle from a determined protected location, a distance of the vehicle from the vegetation.

As used herein, a camera is a device for capturing and/or recording visual images. These images may be in the form of still shots, analog video signals, or digital video signals. The signals, particularly the digital video signals, may be subject to compression/decompression algorithms, such as MPEG or HEVC, for example. A suitable camera may capture and record in a determined band of wavelengths of light or energy. For example, in one embodiment the camera may sense wavelengths in the visible spectrum and in another the camera may sense wavelengths in the infrared spectrum. Multiple sensors may be combined in a single camera and may be used selectively based on the application. Further, stereoscopic and 3D cameras are contemplated for at least some embodiments described herein. These cameras may assist in determining distance, velocity, and vectors to predict (and thereby avoid) collision and damage. The term consist, or vehicle consist, refers to two or more vehicles or items of mobile equipment that are mechanically or logically coupled to each other. By logically coupled, the plural items of mobile equipment are controlled so that controls to move one of the items causes a corresponding movement in the other items in consist, such as by wireless command. An Ethernet over multiple unit (eMU) system may include, for example, a communication system for use transmitting data from one vehicle to another in the consist (e.g., an Ethernet network over which data is communicated between two or more vehicles).

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy, platoon, swarm, fleet, and the like).

During use, the controller responds to the environmental information or to operator input by switching operating modes of the vehicle and/or of the directed energy system. The controller may switch operating modes to selectively control one or more of activating only a portion of the directed energy system. For example, if sensors or maps indicate that there is equipment and/or people on one side of the vehicle at a location on the route and tall weeds in a ditch on the other side then the controller may control the directed energy system to activate the directed energy beam sources on the side with the weeds but not activate on the side with the equipment and/or people. Further, the controller may ensure that directed energy beam sources face downward to cover the weeds that are lower than the route because they are in a ditch. That is, the directed energy system may have one or more directed energy beam sources and these are organized into subsets, wherein the subsets may be on one or more of one side of the vehicle relative to the other, high emitting, low emitting, horizontal emitting, forward emitting, and rearward emitting. The directed energy beam sources may have adjustable focusing and projecting assemblies that may selectively emit wide directed energy beams and/or narrow directed energy beams. The directed energy system may have one or more adjustable directed energy beam sources that may be selectively pointed in determined directions. The controller may determine, based at least in part on environmental information, that a particular type of foliage is present, a preferred directed energy beam is effective (and selected by the controller), as well as whether the selected directed energy beam should be applied to the meristems, leaves/stalk, bark, and/or to the roots/soil; and the appropriate directed energy beam sources and focusing assemblies are activated by the controller to deliver the directed energy beams as determined.

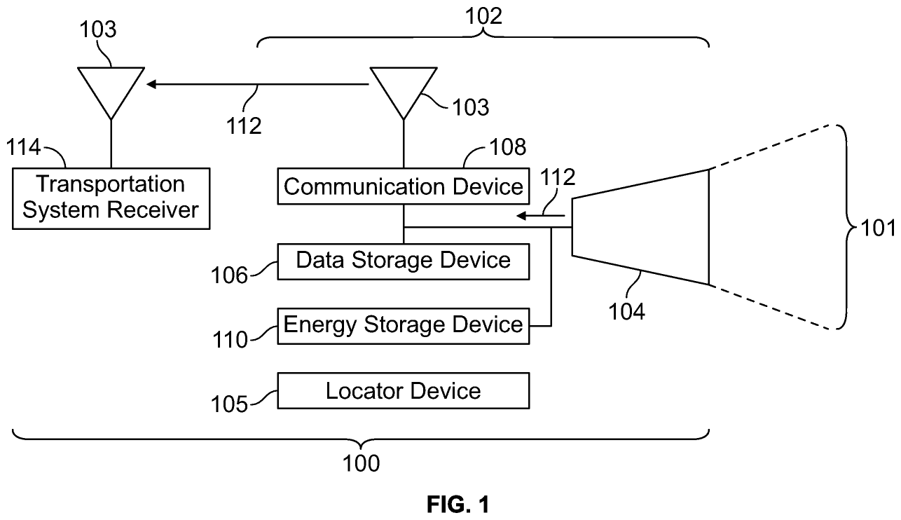

FIG. 1 illustrates a control system 100 for a vehicle (not shown in FIG. 1) that may capture and communicate data related to an environmental condition of a route over which the vehicle may travel and to determine actions to take relative to vegetation adjacent to that route, and the like according to one embodiment.

The environmental information acquisition system includes a portable unit 102 having a camera 104, a data storage device 106 and/or a communication device 108, and a battery or other energy storage device 110. The portable unit may be portable in that the portable unit is small and/or light enough to be carried by a single adult human, however there are some embodiments in which a larger unit or one that is permanently affixed to the vehicle would be suitable. The portable unit may capture and/or generate image data 112 of a field of view 101. For example, the field of view may represent a solid angle or area over which the portable unit may be exposed to the environment and thereby to generate environmental information. The image data may include still images, videos (e.g., moving images or a series of images representative of a moving object), or the like, of one or more objects within the field of view of the portable unit. In any of the embodiments of any of the systems described herein, data other than image data may be captured and communicated. For example, the portable unit may have sensors for capturing image data outside of the visible light spectrum or a microphone for capturing audio data, a vibration sensor for capturing vibration data, elevation and location data, information relating to the grade/slope, and the surrounding terrain, and so on. Terrain information may include whether there is a hill side, a ditch, or flat land adjacent to the route, whether there is a fence or a building, information about the state of the route itself (e.g., ballast and ties, painted lines, and the like), and information about the vegetation. The vegetation information may include the density of the foliage, the type of foliage, the thickness of the stalks, the distance from the route, the overhang of the route by the foliage, and the like.

A suitable portable unit may include an Internet protocol camera, such as a camera that may send video data via the Internet or another network. In one aspect, the camera may be a digital camera capable of obtaining relatively high-quality image data (e.g., static or still images and/or videos). For example, the camera may be an Internet protocol (IP) camera that generates packetized image data. A suitable camera may be a high definition (HD) camera capable of obtaining image data at relatively high resolutions.

The data storage device may be electrically connected to the portable unit and may store the image data. The data storage device may include one or more computer hard disk drives, removable drives, magnetic drives, read only memories, random access memories, flash drives or other solid state storage devices, or the like. The data storage device may be disposed remote from the portable unit, such as by being separated from the portable unit by at least several centimeters, meters, kilometers, as determined at least in part by the application at hand.

The communication device may be electrically connected to the portable unit and may communicate (e.g., transmit, broadcast, or the like) the image data to a transportation system receiver 114 located off-board the portable unit. The image data may be communicated to the receiver via one or more wired connections, over power lines, through other data storage devices, or the like. The communication device and/or receiver may represent hardware circuits or circuitry, such as transceiving circuitry and associated hardware (e.g., antennas) 103, that include and/or are connected with one or more processors (e.g., microprocessors, controllers, or the like).

In one embodiment, the portable unit includes the camera, the data storage device, and the energy storage device, but not the communication device. In such an embodiment, the portable unit may be used for storing captured image data for later retrieval and use. In another embodiment, the portable unit comprises the camera, the communication device, and the energy storage device, but not the data storage device. In such an embodiment, the portable unit may be used to communicate the image data to a vehicle or other location for immediate use (e.g., being displayed on a display screen), and/or for storage remote from the portable unit (this is, for storage not within the portable unit). In another embodiment, the portable unit comprises the camera, the communication device, the data storage device, and the energy storage device. In such an embodiment, the portable unit may have multiple modes of operation, such as a first mode of operation where image data is stored within the portable unit on the data storage device 106, and a second mode of operation where the image data is transmitted off the portable unit for remote storage and/or immediate use elsewhere.

A suitable camera may be a digital video camera, such as a camera having a lens, an electronic sensor for converting light that passes through the lens into electronic signals, and a controller for converting the electronic signals output by the electronic sensor into the image data, which may be formatted according to a standard such as MP4. The data storage device, if present, may be a hard disc drive, flash memory (electronic non-volatile non-transitory computer storage medium), or the like. The communication device, if present, may be a wireless local area network (LAN) transmitter (e.g., Wi-Fi transmitter), a radio frequency (RF) transmitter that transmits in and according to one or more commercial cell frequencies/protocols (e.g., 3G or 4G), and/or an RF transmitter that may wirelessly communicate at frequencies used for vehicle communications (e.g., at a frequency compatible with a wireless receiver of a distributed power system of a rail vehicle; distributed power refers to coordinated traction control, such as throttle and braking, of a train or other rail vehicle consist having plural locomotives or other powered rail vehicle units). A suitable energy storage device may be a rechargeable lithium-ion battery, a rechargeable Ni-MH battery, an alkaline cell, or other device suitable for portable energy storage for use in an electronic device. Another suitable energy storage device, albeit more of an energy provider than storage, include a vibration harvester and a solar panel, where energy is generated and then provided to the camera system.

The portable unit may include a locator device 105 that generates data used to determine the location of the portable unit. The locator device may represent one or more hardware circuits or circuitry that include and/or are connected with one or more processors (e.g., controllers, microprocessors, or other electronic logic-based devices). In one example, the locator device is selected from a global positioning system (GPS) receiver that determines a location of the portable unit, a beacon or other communication device that broadcasts or transmits a signal that is received by another component (e.g., the transportation system receiver) to determine how far the portable unit is from the component that receives the signal (e.g., the receiver), a radio frequency identification (RFID) tag or reader that emits and/or receives electromagnetic radiation to determine how far the portable unit is from another RFID reader or tag (e.g., the receiver), or the like. The receiver may receive signals from the locator device to determine the location of the locator device 105 relative to the receiver and/or another location (e.g., relative to a vehicle or vehicle system). Additionally, or alternatively, the locator device may receive signals from the receiver (e.g., which may include a transceiver capable of transmitting and/or broadcasting signals) to determine the location of the locator device relative to the receiver and/or another location (e.g., relative to a vehicle or vehicle system).

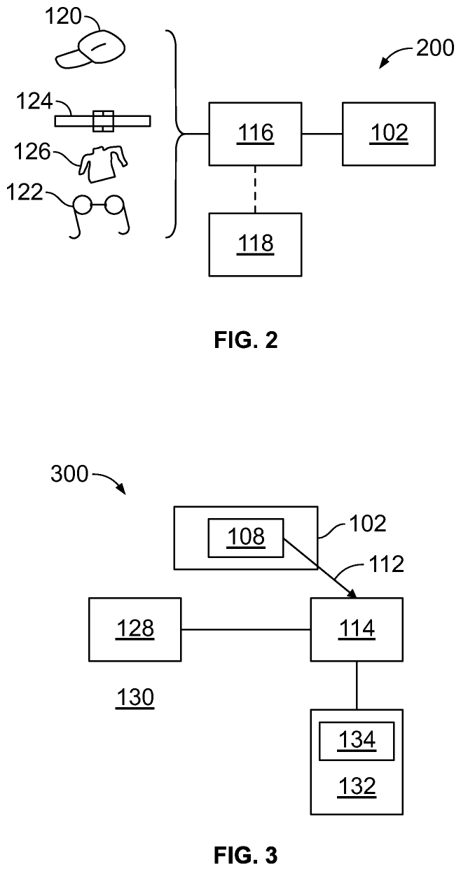

FIG. 2 illustrates an environmental information capture system 200 according to another embodiment. This system includes a garment 116 that may be worn or carried by an operator 118, such as a vehicle operator, transportation worker, or other person. A portable unit or locator device may be attached to the garment. For example, the garment may be a hat 120 (including a garment worn about the head), an ocular device 122 (e.g., a Google Glass™ device or other eyepiece), a belt or watch 124, part of a jacket 126 or other outer clothing, a clipboard, or the like. The portable unit may detachably connect to the garment, or, in other embodiments, the portable unit may be integrated into, or otherwise permanently connected to the garment. Attaching the portable unit to the garment may allow the portable unit to be worn by a human operator of a vehicle (or the human operator may be otherwise associated with a transportation system), for capturing image data associated with the human operator performing one or more functions with respect to the vehicle or transportation system more generally. The controller may determine if the operator is within a spray zone of one or more dispenser. If the operator is detected within the spray zone, the controller may block or prevent the dispenser from spraying the spray chemical through one or more of the nozzles.

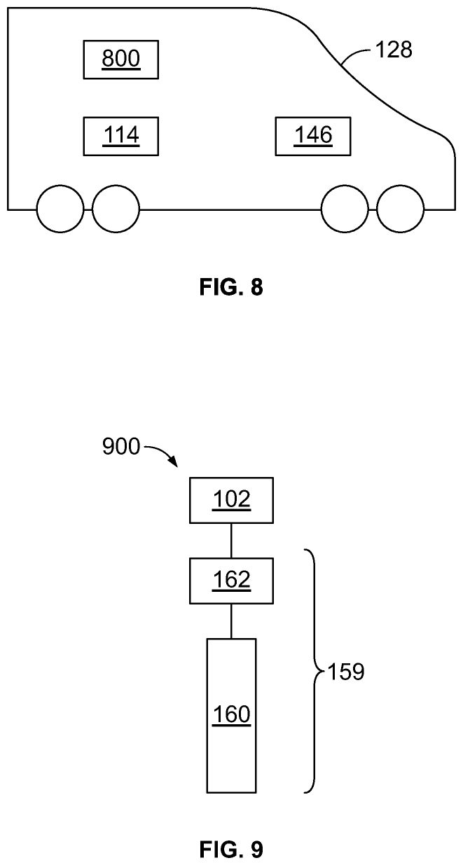

With reference to FIG. 3, in one embodiment, the portable unit may include the communication device, which may wirelessly communicate the image data to the transportation system receiver. The transportation system receiver may be located onboard a vehicle 128, at a wayside location 130 of a route of the vehicle, or otherwise remote from the vehicle. The illustrated vehicle (see also FIG. 8) is a high rail vehicle that may selectively travel on a rail track and on a roadway. Remote may refer to not being onboard the vehicle, and in embodiments, more specifically, to not within the immediate vicinity of the vehicle, such as not within a Wi-Fi and/or cellular range of the vehicle. In one aspect, the portable unit may be fixed to the garment being worn by an operator of the vehicle and provide image data representative of areas around the operator. For example, the image data may represent the areas being viewed by the operator. The image data may no longer be generated by the portable unit during time periods that the operator is within the vehicle or within a designated distance from the vehicle. Upon exiting the vehicle or moving farther than the designated distance (e.g., five meters) from the vehicle, the portable unit may begin automatically generating and/or storing the image data. As described herein, the image data may be communicated to a display onboard the vehicle or in another location so that another operator onboard the vehicle may determine the location of the operator with the portable unit based on the image data. With respect to rail vehicles, one such instance could be an operator exiting the cab of a locomotive. If the operator is going to switch out cars from a rail vehicle that includes the locomotive, the image data obtained by the portable unit on the garment worn by the operator may be recorded and displayed to an engineer onboard the locomotive. The engineer may view the image data as a double check to ensure that the locomotive is not moved if the conductor is between cars of the rail vehicle. Once it is clear from the image data that the conductor is not in the way, then the engineer may control the locomotive to move the rail vehicle.

The image data may be autonomously examined by one or more image data analysis systems or image analysis systems described herein. For example, one or more of the transportation receiver system 114, the vehicle, and/or the portable unit may include an image data analysis system (also referred to as an image analysis system) that examines the image data for one or more purposes described herein.

Continuing, FIG. 3 illustrates one embodiment of a camera system 300 according to an embodiment of the invention. The system may include a display screen system 132 located remote from the portable unit and from the vehicle. The display screen system receives the image data from the transportation system receiver as a live feed and display the image data (e.g., converted back into moving images) on a display screen 134 of the display screen system. The live feed may include image data representative of objects contemporaneous with capturing the video data but for communication lags associated with communicating the image data from the portable unit to the display screen system. Such an embodiment may be used, for example, for communicating image data, captured by a human operator wearing or otherwise using the portable unit and associated with the human operator carrying out one or more tasks associated with a vehicle (e.g., vehicle inspection) or otherwise associated with a transportation network (e.g., rail track inspection), to a remote human operator viewing the display screen. A remote human operator, for example, may be an expert in the particular task or tasks, and may provide advice or instructions to the on-scene human operator based on the image data or may actuate and manipulate a dispenser system, maintenance equipment, and the vehicle itself.

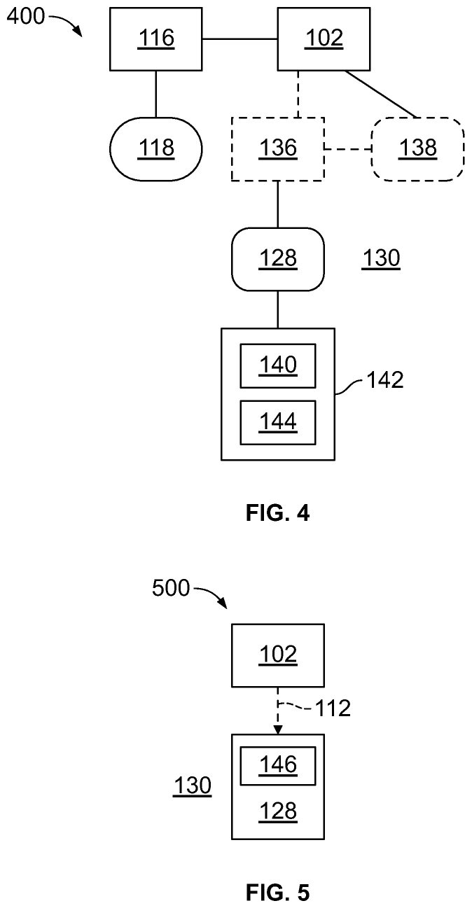

FIG. 4 illustrates one embodiment of a camera system 400 having a garment and a portable unit attached and/or attachable to the garment. The system may be similar to the other camera systems described herein, with the system further including a position detection unit 136 and a control unit 138. The position detection unit detects a position of the transportation worker wearing the garment. The configurable position detection unit may be connected to and part of the garment, connected to and part of the portable unit, or connected to and part of the vehicle or a wayside device. The position detection unit may be, for example, a global positioning system (GPS) unit, or a switch or other sensor that detects when the human operator (wearing the garment) is at a particular location in a vehicle, outside but near the vehicle, or otherwise. In one embodiment, the position detection unit may detect the presence of a wireless signal when the portable unit is within a designated range of the vehicle or vehicle cab. The position detection unit may determine that the portable unit is no longer in the vehicle or vehicle cab responsive to the wireless signal no longer being detected or a strength of the signal dropping below a designated threshold. In one embodiment, the

[symbol]

The control unit (which may be part of the portable unit) controls the portable unit based at least in part on the position of the transportation worker that is detected by the position detection unit. The control unit may represent hardware circuits or circuitry that include and/or are connected with one or more processors (e.g., microprocessors, controllers, or the like).

In one embodiment, the control unit controls the portable unit to a first mode of operation when the position of the transportation worker that is detected by the position detection unit indicates the transportation worker is at an operator terminal 140 of the vehicle (e.g., in a cab 142 of the vehicle), and to control the portable unit to a different, second mode of operation when the position of the transportation worker that is detected by the position detection unit indicates the transportation worker is not at the operator terminal of the vehicle. In the first mode of operation, for example, the portable unit is disabled from at least one of capturing, storing, and/or communicating the image data, and in the second mode of operation, the portable unit is enabled to capture, store, and/or communicate the image data. In such an embodiment, therefore, it may be the case that the portable unit is disabled from capturing image data when the operator is located at the operator terminal, and enabled when the operator leaves the operator terminal. The control unit may cause the camera to record the image data when the operator leaves the operator cab or operator terminal so that actions of the operator may be tracked. For example, in the context of a rail vehicle, the movements of the operator may be examined using the image data to determine if the operator is in a safe area during operation of a set of dispensers or maintenance equipment.

In one embodiment, the control unit may control the portable unit to a first mode of operation when the position of the transportation worker that is detected by the position detection unit 136 indicates the transportation worker is in an operator cab 142 of the vehicle and to control the portable unit to a different, second mode of operation when the position of the transportation worker that is detected by the position detection unit indicates the transportation worker is not in the operator cab of the vehicle. For example, the portable unit may be enabled for capturing image data when the operator is outside the operator cab and disabled for capturing image data when the operator is inside the operator cab with no view of the environment. This may be a powered down mode to save on battery life.

In another embodiment, the system has a display screen 144 in the operator cab of the rail vehicle. The communication device of the portable unit may transmit the image data to the transportation system receiver which may be located onboard the vehicle and operably connected to the display screen, for the image data to be displayed on the display screen. Such an embodiment may be used for one operator of a vehicle to view the image data captured by another operator of the vehicle using the portable unit. For example, if the portable camera system is attached to a garment worn by the one operator when performing a task external to the vehicle, video data associated with the task may be transmitted back to the other operator remaining in the operator cab, for supervision or safety purposes.

FIG. 5 illustrates one embodiment of a camera system 500. A control system 146 onboard the vehicle may perform one or more of controlling movement of the vehicle, movement of maintenance equipment, and operation of one or more dispensers (not shown). The control system may control operations of the vehicle, such as by communicating command signals to a propulsion system of the vehicle (e.g., motors, engines, brakes, or the like) for controlling output of the propulsion system. That is, the control system may control the movement (or not) of the vehicle, as well as its speed and/or direction.

The control system may prevent movement of the vehicle responsive to a first data content of the image data and allow movement of the vehicle responsive to a different, second data content of the image data. For example, the control system onboard the vehicle may engage brakes and/or prevent motors from moving the vehicle to prevent movement of the vehicle, movement of the maintenance equipment, or operation of the dispenser responsive to the first data content of the image data indicating that the portable unit (e.g., worn by an operator, or otherwise carried by an operator) is located outside the operator cab of the vehicle and to allow movement and operation responsive to the second data content of the image data indicating that the portable unit is located inside the operator cab.

The data content of the image data may indicate that the portable unit is outside of the operator cab based on a change in one or more parameters of the image data. One of these parameters may include brightness or intensity of light in the image data. For example, during daylight hours, an increase in brightness or light intensity in the image data may indicate that the operator and the portable unit has moved from inside the cab to outside the cab. A decrease in brightness or light intensity in the image data may indicate that the operator and the portable unit has moved from outside the cab to inside the cab. Another parameter of the image data may include the presence or absence of one or more objects in the image data. For example, the control system may use one or more image and/or video processing algorithms, such as edge detection, pixel metrics, comparisons to benchmark images, object detection, gradient determination, or the like, to identify the presence or absence of one or more objects in the image data. If the object is inside the cab or vehicle, then the inability of the control system to detect the object in the image data may indicate that the operator is no longer in the cab or vehicle. But, if the object is detected in the image data, then the control system may determine that the operator is in the cab or vehicle.

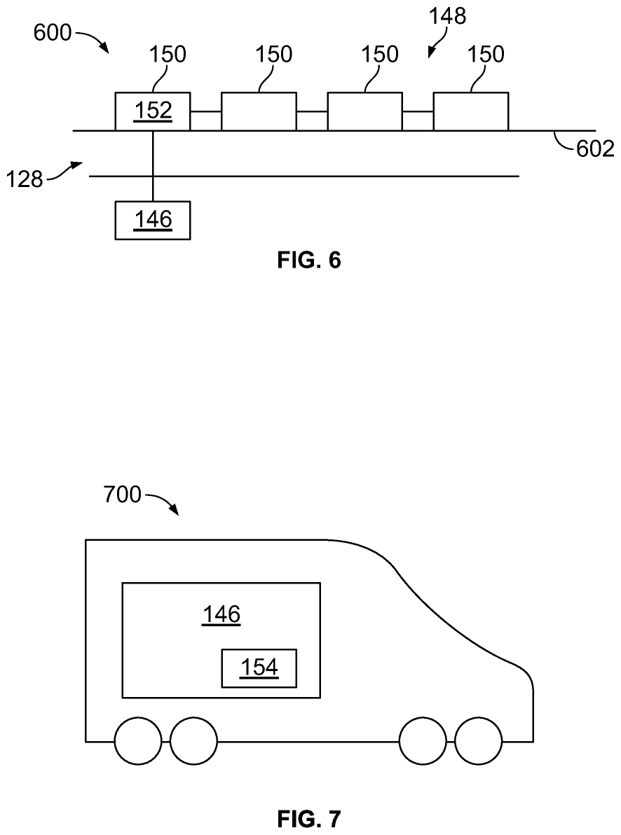

FIG. 6 illustrates one embodiment of a vehicle system 600 that has a vehicle consist (i.e., a group or swarm) 148 that includes plural communicatively interconnected vehicle units 150, with at least one of the plural vehicle units being a lead vehicle unit 152. The vehicle system may be a host of autonomous or semi-autonomous drones. Other suitable vehicles may be an automobile, agricultural equipment, high-rail vehicle, locomotive, marine vessel, mining vehicle, other off-highway vehicle (e.g., a vehicle that is not designed for and/or legally permitted to travel on public roadways), and the like. The consist may represent plural vehicle units communicatively connected and controlled so as to travel together along a route 602, such as a track, road, waterway, or the like. The controller may send command signals to the vehicle units to instruct the vehicle units how to move along the route to maintain speed, direction, separation distances between the vehicle units, and the like.

The control system may prevent movement of the vehicles in the consist responsive to the first data content of the environmental information indicating that the portable unit is positioned in an unsafe area (or not in a safe area) and to allow movement of the vehicles in the consist responsive to the second data content of the environmental information indicating that the portable unit is not positioned in and unsafe area (or in a known safe area). Such an embodiment may be used, for example, for preventing vehicles in a consist from moving when an operator, wearing or otherwise carrying the portable unit, is positioned in a potentially unsafe area relative to any of the vehicle units.

FIG. 7 illustrates the control system according to one embodiment. The control system 146 may be disposed onboard a high rail vehicle 700 and may include an image data analysis system 154. The illustrated vehicle is a high rail vehicle that may selectively travel on a rail track and on a roadway. The analysis system may automatically process the image data for identifying the first data content and the second data content in the image data and thereby generate environmental information. The control system may automatically prevent and allow movement of the vehicle responsive to the first data and the second data, respectively, that is identified by the image data analysis system. The image data analysis system may include one or more image analysis processors that autonomously examine the image data obtained by the portable unit for one or more purposes, as described herein.

FIG. 8 illustrates the transportation system receiver located onboard the vehicle 800 according to one embodiment. The transportation system receiver may wirelessly communicate network data onboard and/or off-board the vehicle, and/or to automatically switch to a mode for receiving the environmental information from the portable unit responsive to the portable unit being active to communicate the environmental information. For example, responsive to the portable unit being active to transmit the environmental information, the transportation system receiver may switch from a network wireless client mode of operation (transmitting data originating from a device onboard the vehicle, such as the control unit) to the mode for receiving the environmental information from the portable unit. The mode for receiving the environmental information from the portable unit may include a wireless access point mode of operation (receiving data from the portable unit).

In another embodiment, the portable unit may include the transportation system receiver located onboard the vehicle. The transportation system receiver may wirelessly communicate network data onboard and/or off-board the vehicle, and/or to automatically switch from a network wireless client mode of operation to a wireless access point mode of operation, for receiving the environmental information from the portable unit. This network data may include data other than environmental information. For example, the network data may include information about an upcoming trip of the vehicle (e.g., a schedule, grades of a route, curvature of a route, speed limits, areas under maintenance or repair, etc.), cargo being carried by the vehicle, or other information. Alternatively, the network data may include the image data. The receiver may switch modes of operation and receive the environmental information responsive to at least one designated condition of the portable unit. For example, the designated condition may be the potable portable unit being operative to transmit the environmental information, or the portable unit being in a designated location. As another example, the designated condition may be movement or the lack of movement of the portable unit. Responsive to the receiver and/or portable unit determining that the portable unit has not moved and/or has not moved into or out of the vehicle, the portable unit may stop generating the environmental information, the portable unit may stop communicating the environmental information to the receiver, and/or the receiver may stop receiving the environmental information from the portable unit. Responsive to the receiver and/or portable unit determining that the portable unit is moving and/or has moved into or out of the vehicle, the portable unit may begin generating the environmental information, the portable unit may begin communicating the environmental information to the receiver, and/or the receiver may begin receiving the environmental information from the portable unit.

In another embodiment of one or more of the systems described herein, the system is configured so that the image data/environmental information may be stored and/or used locally (e.g., in the vehicle), or to be transmitted to a remote location (e.g., off-vehicle location) based on where the vehicle is located. For example, if the vehicle is in a yard (e.g., a switching yard, maintenance facility, or the like), the environmental information may be transmitted to a location in the yard. But, prior to the vehicle entering the yard or a designated location in the yard, the environmental information may be stored onboard the vehicle and not communicated to any location off the vehicle.

Thus, in an embodiment, the system further comprises a control unit that, responsive to at least one of a location of the portable unit or a control input, controls at least one of the portable unit or the transportation system receiver to a first mode of operation for at least one of storing or displaying the video data on board the rail vehicle and to a second mode of operation for communicating the video data off board the rail vehicle for at least one of storage or display of the video data off board the rail vehicle. For example, the control unit may control at least one of the portable unit or the transportation system receiver from the first mode of operation to the second mode of operation responsive to the location of the portable unit being indicative of the rail vehicle being in a city or populated area.

During operation of the vehicle and/or portable unit outside of a designated area (e.g., a geofence extending around a vehicle yard or other location), the image data generated by the camera may be locally stored in the data storage device of the portable unit, shown on a display of the vehicle, or the like. Responsive to the vehicle and/or portable unit entering into the designated area, the portable unit may switch modes to begin wirelessly communicating the image data to the receiver, which may be located in the designated area. Changing where the image data is communicated based on the location of the vehicle and/or portable unit may allow for the image data to be accessible to those operators viewing the image data for safety, analysis, or the like. For example, during movement of the vehicle outside of the vehicle yard, the image data may be presented to an onboard operator, and/or the image data may be analyzed by an onboard analysis system of the vehicle to generate environmental information and ensure safe operation of the vehicle. Responsive to the vehicle and/or portable unit entering into the vehicle yard, the image data and/or environmental information may be communicated to a central office or management facility for remote monitoring of the vehicle and/or operations being performed near the vehicle.

As one example, event data transmission (e.g., the transmitting, broadcasting, or other communication of image data) may occur based on various vehicle conditions, geographic locations, and/or situations. The image data and/or environmental information may be either pulled (e.g., requested) or pushed (e.g., transmitted and/or broadcast) from the vehicle. For example, image data may be sent from a vehicle to an off-board location based on selected operating conditions (e.g., emergency brake application), a geographic location (e.g., in the vicinity of a crossing between two or more routes), selected and/or derived operating areas of concern (e.g., high wheel slip or vehicle speed exceeding area limits), and/or time driven messages (e.g., sent once a day). The off-board location may request and retrieve the image data from specific vehicles on demand.

FIG. 9 illustrates another embodiment of a camera system 900. The system includes a portable support 159 having at least one leg 160 and a head 162 attached to the at least one leg. The head detachably couples to the portable unit, and the at least one leg autonomously supports (e.g., without human interaction) the portable unit at a wayside location off-board the vehicle. The support may be used to place the portable unit in a position to view at least one of the vehicle and/or the wayside location. The communication device may wirelessly communicate the image data to the transportation system receiver that is located onboard the vehicle. The image data may be communicated from off-board the vehicle to onboard the vehicle for at least one of storage and/or display of the image data onboard the vehicle. In one example, the portable support may be a camera tripod. The portable support may be used by an operator to set up the portable unit external to the vehicle, for transmitting the image data back to the vehicle for viewing in an operator cab of the vehicle or in another location. The image data may be communicated to onboard the vehicle to allow the operator and/or another passenger of the vehicle to examine the exterior of the vehicle, to examine the wayside device and/or location, to examine the route on which the vehicle is traveling, or the like. In one example, the image data may be communicated onboard the vehicle from an off-board location to permit the operator and/or passengers to view the image data for entertainment purposes, such as to view films, videos, or the like.

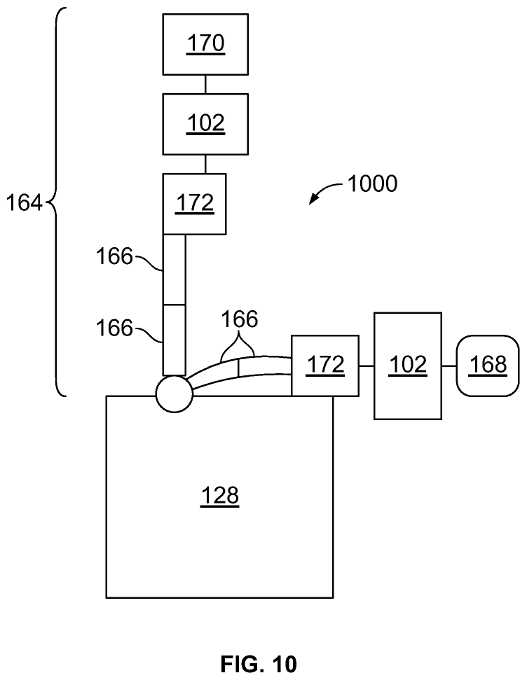

FIG. 10 illustrates an embodiment of a spray system 1000. The system includes a controllable mast 164 that may be attached to a platform of the vehicle. The controllable mast has one or more mast segments 166 that support a maintenance equipment implement 168 and a dispenser 170 relative to the vehicle. The controllable mast includes a coupler 172 attached to at least one of the mast segments. The coupler allows for controlled movement and deployment of the maintenance equipment and/or the dispenser. A portable unit 102 may be coupled to the controllable mast. The controllable mast may be retractable, for example by providing the mast segments as telescoping segments and/or by providing the coupler as extendable from and retractable into the controllable mast. For example, the coupler may have a telescoping structure or be otherwise extensible or retractable by using a piston and rod arrangement, such as a hydraulic piston. The controllable mast may use such a piston and rod arrangement.

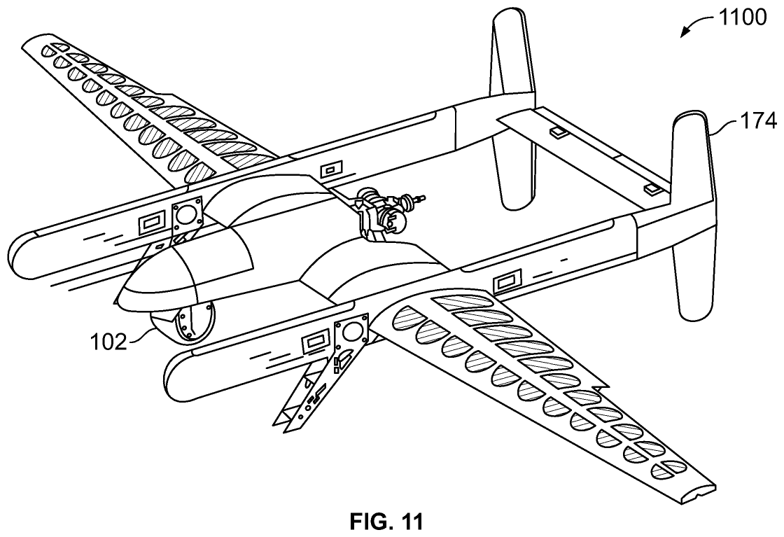

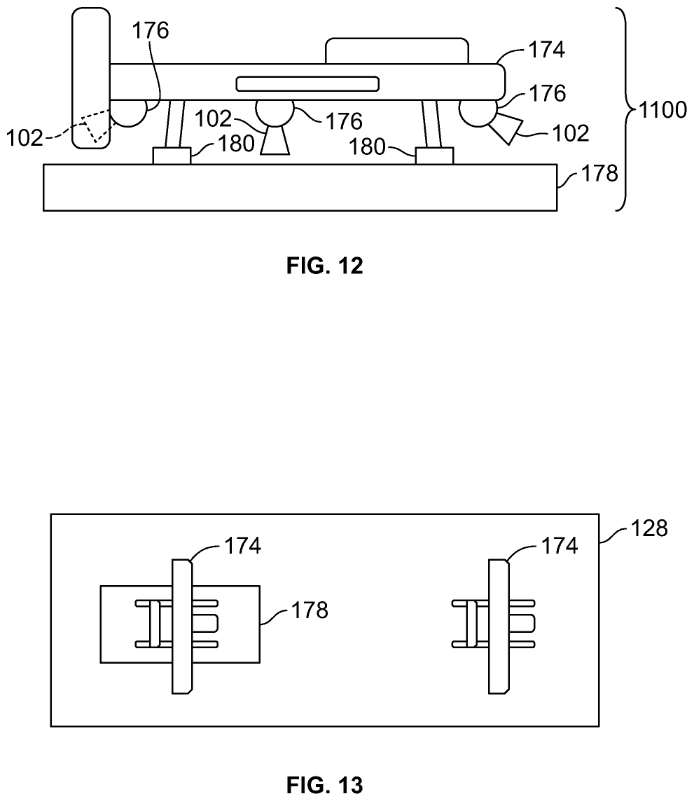

FIGS. 11, 12, and 13 illustrate an embodiment of an environmental information acquisition system 1100. FIG. 11 illustrates a perspective view of the system, FIG. 12 illustrates a side view of the system, and FIG. 13 illustrates a top view of the system 1100. The system includes an aerial device 174 that may navigate via one of remote control or autonomous operation while flying over a route of the ground vehicle. The aerial device may have one or more docks 176 for receiving one or more portable units and may have a vehicle dock for coupling the aerial device to the vehicle. In the illustrated example, the aerial device includes three cameras, with one portable unit facing along a forward direction of travel 1200 of the aerial device, another portable unit facing along a downward direction 1202 toward the ground or route over which the aerial device flies, and another portable unit facing along a rearward direction 1204 of the aerial device. Alternatively, a different number of portable units may be used and/or the portable units may be oriented in other directions.

When the aerial device is in the air, the portable units may be positioned for the cameras to view the route, the vehicle, or other areas near the vehicle. The aerial device may be, for example, a scale dirigible, a scale helicopter, an aircraft, or the like. By “scale” it means that the aerial device may be smaller than needed for transporting humans, such as 1/10 scale or smaller of a human transporting vehicle. A suitable scale helicopter may include multi-copters and the like.

The system may include an aerial device vehicle dock 178 to attach the aerial device to the vehicle. The aerial device vehicle dock may receive the aerial device for at least one of detachable coupling of the aerial device to the vehicle, charging of a battery of the aerial device from a power source of the vehicle, or the like. For example, the dock may include one or more connectors 180 that mechanically or magnetically coupled with the aerial device to prevent the aerial device from moving relative to the dock, that conductively couple an onboard power source (e.g., battery) of the aerial device with a power source of the vehicle (e.g., generator, alternator, battery, pantograph, or the like) so that the power source of the aerial device may be charged by the power source of the vehicle during movement of the vehicle.

The aerial device may fly off of the vehicle to obtain image data that is communicated from one or more of the cameras onboard the aerial device to one or more receivers 114 onboard the vehicle and converted to environmental information. The aerial device may fly relative to the vehicle while the vehicle is stationary and/or while the vehicle is moving along a route. The environmental information may be displayed to an operator on a display device onboard the vehicle and/or may be autonomously examined as described herein by the controller that may operate the vehicle, the maintenance equipment, and/or the dispenser. When the aerial device is coupled into the vehicle dock, one or more cameras may be positioned to view the route during movement of the vehicle.

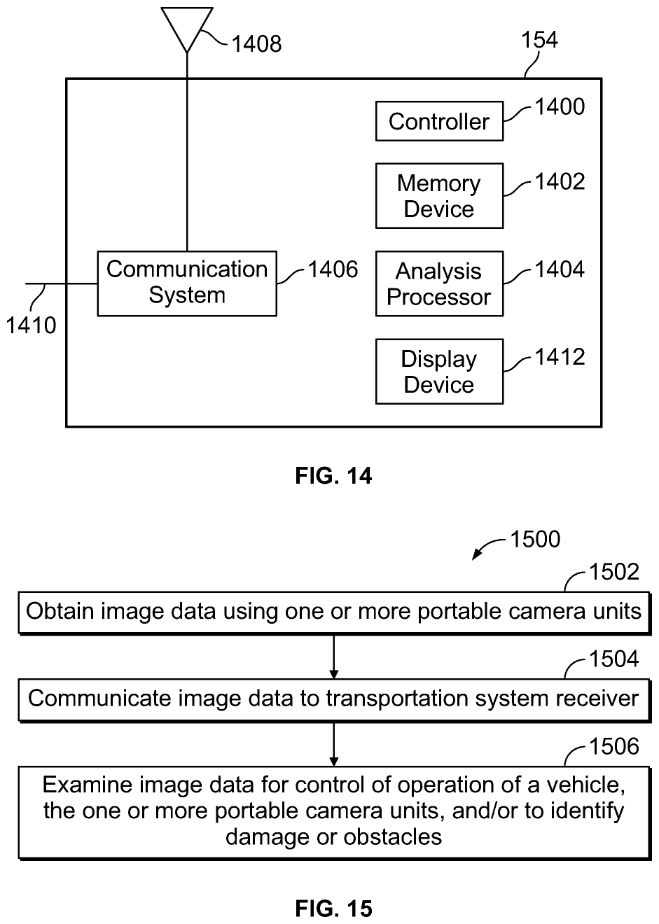

FIG. 14 is a schematic illustration of the image analysis system 154 according to one embodiment. As described herein, the image analysis system may be used to examine the data content of the image data to automatically identify objects in the image data, aspects of the environment (such as foliage), and the like. A controller 1400 of the system includes or represents hardware circuits or circuitry that includes and/or is connected with one or more computer processors, such as one or more computer microprocessors. The controller may save image data obtained by the portable unit to one or more memory devices 1402 of the imaging system, generate alarm signals responsive to identifying one or more problems with the route and/or the wayside devices based on the image data that is obtained, or the like. The memory device 1402 includes one or more computer readable media used to at least temporarily store the image data. A suitable memory device may include a computer hard drive, flash or solid state drive, optical disk, or the like.

Additionally, or alternatively, the image data and/or environmental information may be used to inspect the health of the route, status of wayside devices along the route being traveled on by the vehicle, or the like. The field of view of the portable unit may encompass at least some of the route and/or wayside devices disposed ahead of the vehicle along a direction of travel of the vehicle. During movement of the vehicle along the route, the portable unit may obtain image data representative of the route and/or the wayside devices for examination to determine if the route and/or wayside devices are functioning properly, or have been damaged, need repair or maintenance, need application of the spray composition, and/or need further examination or action.

The image data created by the portable unit may be referred to as machine vision, as the image data represents what is seen by the system in the field of view of the portable unit. One or more analysis processors 1404 of the system may examine the image data to identify conditions of the vehicle, the route, and/or wayside devices and generate the environmental information. The analysis processor may examine the terrain at, near, or surrounding the route and/or wayside devices to determine if the terrain has changed such that maintenance of the route, wayside devices, and/or terrain is needed. For example, the analysis processor may examine the image data to determine if vegetation (e.g., trees, vines, bushes, and the like) is growing over the route or a wayside device (such as a signal) such that travel over the route may be impeded and/or view of the wayside device may be obscured from an operator of the vehicle. As another example, the analysis processor may examine the image data to determine if the terrain has eroded away from, onto, or toward the route and/or wayside device such that the eroded terrain is interfering with travel over the route, is interfering with operations of the wayside device, or poses a risk of interfering with operation of the route and/or wayside device. Thus, the terrain “near” the route and/or wayside device may include the terrain that is within the field of view of the portable unit when the route and/or wayside device is within the field of view of the portable unit, the terrain that encroaches onto or is disposed beneath the route and/or wayside device, and/or the terrain that is within a designated distance from the route and/or wayside device (e.g., two meters, five meters, ten meters, or another distance). The analysis processor may represent hardware circuits and/or circuitry that include and/or are connected with one or more processors, such as one or more computer microprocessors, controllers, or the like.

Acquisition of image data from the portable unit may allow for the analysis processor 1404 to have access to sufficient information to examine individual video frames, individual still images, several video frames, or the like, and determine the condition of the wayside devices and/or terrain at or near the wayside device. The image data may allow for the analysis processor to have access to sufficient information to examine individual video frames, individual still images, several video frames, or the like, and determine the condition of the route. The condition of the route may represent the health of the route, such as a state of damage to one or more rails of a track, the presence of foreign objects on the route, overgrowth of vegetation onto the route, and the like. As used herein, the term “damage” may include physical damage to the route (e.g., a break in the route, pitting of the route, or the like), movement of the route from a prior or designated location, growth of vegetation toward and/or onto the route, deterioration in the supporting material (e.g., ballast material) beneath the route, or the like. For example, the analysis processor may examine the image data to determine if one or more rails are bent, twisted, broken, or otherwise damaged. The analysis processor may measure distances between the rails to determine if the spacing between the rails differs from a designated distance (e.g., a gauge or other measurement of the route). The analysis of the image data by the analysis processor may be performed using one or more image and/or video processing algorithms, such as edge detection, pixel metrics, comparisons to benchmark images, object detection, gradient determination, or the like.

A communication system 1406 of the system represents hardware circuits or circuitry that include and/or are connected with one or more processors (e.g., microprocessors, controllers, or the like) and communication devices (e.g., wireless antenna 1408 and/or wired connections 1410) that operate as transmitters and/or transceivers for communicating signals with one or more locations. For example, the communication system may wirelessly communicate signals via the antenna and/or communicate the signals over the wired connection (e.g., a cable, bus, or wire such as a multiple unit cable, train line, or the like) to a facility and/or another vehicle system, or the like.

The image analysis system may examine the image data obtained by the portable unit to identify features of interest and/or designated objects in the image data. By way of example, the features of interest may include gauge distances between two or more portions of the route. With respect to rail vehicles, the features of interest that are identified from the image data may include gauge distances between rails of the route. The designated objects may include wayside assets, such as safety equipment, signs, signals, switches, inspection equipment, or the like. The image data may be inspected automatically by the route examination systems to determine changes in the features of interest, designated objects that are missing, designated objects that are damaged or malfunctioning, and/or to determine locations of the designated objects. This automatic inspection may be performed without operator intervention. Alternatively, the automatic inspection may be performed with the aid and/or at the request of an operator.

The image analysis system may use analysis of the image data to detect damage to the route. For example, misalignment of track traveled by rail vehicles may be identified. Based on the detected misalignment, an operator of the vehicle may be alerted so that the operator may implement one or more responsive actions, such as by slowing down and/or stopping the vehicle. When the damaged section of the route is identified, one or more other responsive actions may be initiated. For example, a warning signal may be communicated (e.g., transmitted or broadcast) to one or more other vehicles to warn the other vehicles of the damage, a warning signal may be communicated to one or more wayside devices disposed at or near the route so that the wayside devices may communicate the warning signals to one or more other vehicles, a warning signal may be communicated to an off-board facility that may arrange for the repair and/or further examination of the damaged segment of the route, or the like.

In another embodiment, the image analysis system may examine the image data to identify text, signs, or the like, along the route. For example, information printed or displayed on signs, display devices, vehicles, or the like, indicating speed limits, locations, warnings, upcoming obstacles, identities of vehicles, or the like, may be autonomously read by the image analysis system. The image analysis system may identify information by the detection and reading of information on signs. In one aspect, the image analysis processor may detect information (e.g., text, images, or the like) based on intensities of pixels in the image data, based on wireframe model data generated based on the image data, or the like. The image analysis processor may identify the information and store the information in the memory device. The image analysis processor may examine the information, such as by using optical character recognition to identify the letters, numbers, symbols, or the like, that are included in the image data. This information may be used to autonomously and/or remotely control the vehicle, such as by communicating a warning signal to the control unit of a vehicle, which may slow the vehicle in response to reading a sign that indicates a speed limit that is slower than a current actual speed of the vehicle. As another example, this information may be used to identify the vehicle and/or cargo carried by the vehicle by reading the information printed or displayed on the vehicle.

In another example, the image analysis system may examine the image data to ensure that safety equipment on the route is functioning as intended or designed. For example, the image analysis processor, may analyze image data that shows crossing equipment. The image analysis processor may examine this data to determine if the crossing equipment is functioning to notify other vehicles at a crossing (e.g., an intersection between the route and another route, such as a road for automobiles) of the passage of the vehicle through the crossing.

In another example, the image analysis system may examine the image data to predict when repair or maintenance of one or more objects shown in the image data is needed. For example, a history of the image data may be inspected to determine if the object exhibits a pattern of degradation over time. Based on this pattern, a services team (e.g., a group of one or more personnel and/or equipment) may identify which portions of the object are trending toward a bad condition or already are in bad condition, and then may proactively perform repair and/or maintenance on those portions of the object. The image data from multiple different portable units acquired at different times of the same objects may be examined to determine changes in the condition of the object. The image data obtained at different times of the same object may be examined in order to filter out external factors or conditions, such as the impact of precipitation (e.g., rain, snow, ice, or the like) on the appearance of the object, from examination of the object. This may be performed by converting the image data into wireframe model data, for example.

FIG. 15 illustrates a flowchart of one embodiment of a method 1500 for obtaining and/or analyzing image data for transportation data communication. The method may be practiced by one or more embodiments of the systems described herein. The method includes a step 1502 of obtaining image data using one or more portable units. As described above, the portable units may be coupled to a garment worn by an operator onboard and/or off-board a vehicle, may be coupled to a wayside device that is separate and disposed off-board the vehicle but that may obtain image data of the vehicle and/or areas around the vehicle, may be coupled to the vehicle, may be coupled with an aerial device for flying around and/or ahead of the vehicle, or the like. In one aspect, the portable unit may be in an operational state or mode in which image data is not being generated by the portable unit during time periods that the portable unit is inside of (or outside of) a designated area, such as a vehicle. Responsive to the portable unit moving outside of (or into) the designated area, the portable unit may change to another operational state or mode to begin generating the image data.

The method may include a step 1504 of communicating the image data to the transportation system receiver. For example, the image data may be wirelessly communicated from the portable unit to the transportation system receiver. The image data may be communicated using one or more wired connections. The image data may be communicated as the image data is obtained, or may be communicated responsive to the vehicle and/or the portable unit entering into or leaving a designated area, such as a geofence.

The method may include a step 1506 examining the image data for one or more purposes, such as to control or limit control of the vehicle, to control operation of the portable unit, to identify damage to the vehicle, the route ahead of the vehicle, or the like, and/or to identify obstacles in the route such as encroaching foliage. For example, if the portable unit is worn on a garment of an operator that is off-board the vehicle, then the image data may be analyzed to determine whether the operator is between two or more vehicle units of the vehicle and/or is otherwise in a location where movement of the vehicle would be unsafe (e.g., the operator is behind and/or in front of the vehicle). With respect to vehicle consists, the image data may be examined to determine if the operator is between two or more vehicle units or is otherwise in a location that cannot easily be seen (and is at risk of being hurt or killed if the vehicle consist moves). The image data may be examined to determine if the off-board operator is in a blind spot of the on-board operator of the vehicle, such as behind the vehicle.

An image analysis system described above may examine the image data and, if it is determined that the off-board operator is between vehicle units, is behind the vehicle, and/or is otherwise in a location that is unsafe if the vehicle moves, then the image analysis system may generate a warning signal that is communicated to the control unit of the vehicle. This warning signal may be received by the control unit and, responsive to receipt of this control signal, the control unit may prevent movement of the vehicle. For example, the control unit may disregard movement of controls by an onboard operator to move the vehicle, the control unit may engage brakes and/or disengage a propulsion system of the vehicle (e.g., turn off or otherwise deactivate an engine, motor, or other propulsion-generating component of the vehicle). In one aspect, the image analysis system may examine the image data to determine if the route is damaged (e.g., the rails on which a vehicle is traveling are broken, bent, or otherwise damaged), if obstacles are on the route ahead of the vehicle (e.g., another vehicle or object on the route), or the like.

In one embodiment, the environmental information acquisition system data may be communicated via the controller to an offboard back-office system, where various operational and environmental information may be collected, stored and analyzed. In one back-office system, archival or historic information is collected from at least one vehicle having an environmental information acquisition system. The system may store information regarding one or more of the location of spraying, the type and/or concentration of spray composition, the quantity of spray compensation dispensed, the vehicle speed during the spray event, the environmental data (ditch, hill, curve, straightaway, etc.), the weather at the time of application (rain, cloud cover, humidity, temperature), the time of day and time of season during the spray event, and the like. Further, the system may store information regarding the type of vegetation and other related data as disclosed herein.

With the data collected by the controller, the back-office system may determine an effectiveness over time of a particular treatment regime. For example, the back-office system may note whether subsequent applications of spray composition are excessive (e.g., the weeds in a location are still brown and dead from the last treatment) or insufficient (e.g., the weeds in a location are overgrown relative to the last evaluation by an environmental information acquisition system on a vehicle according to an embodiment of the invention). Further, the back-office system may adjust or change the spray composition suggestions to try different concentrations, different chemical components, different spray application techniques to achieve a desired outcome of foliage control.

In one embodiment, a system (e.g., an environmental information acquisition system) includes a portable unit and a garment. The portable unit includes a camera that may capture at least image data, at least one of a data storage device electrically connected to the camera and may store the image data or a communication device electrically connected to the camera and may wirelessly communicate the image data to a transportation system receiver located off-board the portable unit. The garment may be worn by a transportation worker. The portable unit may be attached to the garment. In one aspect, the garment includes one or more of a hat/helmet, a badge, a smart phone, an electronic watch, or an ocular device. In one aspect, the system may include a locator device that may detect a location of the transportation worker wearing the garment, and a control unit that may control the portable unit based at least in part on the location of the transportation worker that is detected by the locator device. In one aspect, the control unit may control the portable unit to a first mode of operation responsive to the location of the transportation worker that is detected by the locator device indicating that the transportation worker is at an operator terminal of the vehicle and to control the portable unit to a different, second mode of operation responsive to the location of the transportation worker that is detected by the locator device indicating that the transportation worker is not at the operator terminal of the vehicle.

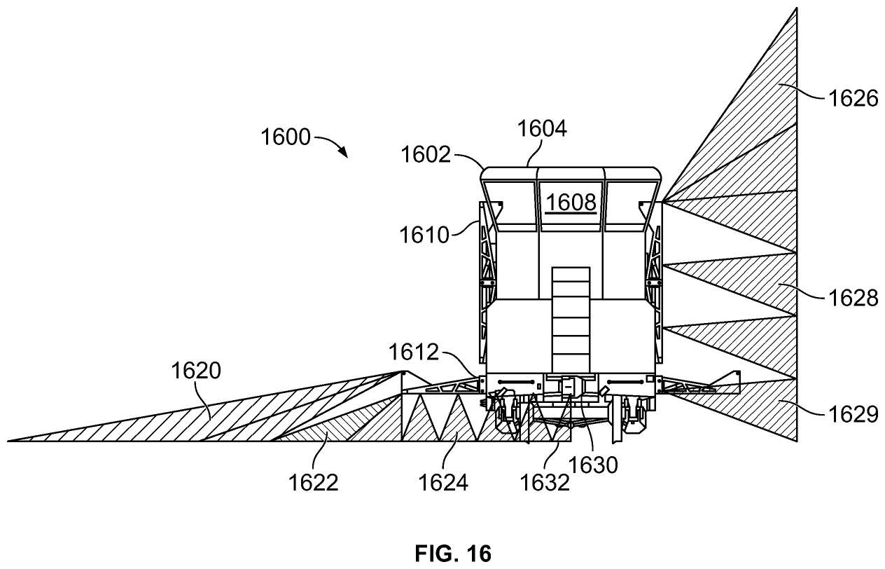

With reference to FIG. 16, a vehicle system 1600 having an embodiment of the invention is show. The vehicle system includes a control cab 1602. The control cab includes a roof 1604 over an operator observation deck (not shown) and a plurality of windows 1608. The windows may be oriented at an angle to allow an improved field of view of an operator on the observation deck in viewing areas of the terrain proximate to the control cab. An extendable boom 1610 is one of a plurality of booms (shown in an upright or tight configuration). An extendable boom 1612 is one of the plurality of booms (shown in an extended or open configuration). The booms may be provided in sets, with each set having plural booms and being located on a side of the vehicle system. The booms, and the sets, may be operated independently of each other, or in a manner that coordinates their action depending on the selected operating mode. Supported by the boom, a plurality of nozzles may provide spray patterns extending from the booms. The location and type of nozzle may produce, for example, and in an extended position, a distal spray pattern 1620, a medial spray pattern 1622, and a proximate spray pattern 1624. While in an upright configuration, the nozzles may produce a relatively high spray pattern 1626, an average height spray pattern 1628, and a low spray pattern 1629. A front rigging 1630 may produce spray patterns 1632 that cover the area in the front (or alternatively in the rear) of the control cab.

During use, as noted herein, the nozzles may be selectively activated. The activation may be accomplished automatically in some embodiments, and manually by an operator in other embodiments. The operator may be located in the observation deck in one embodiment, or may be remote from the vehicle in other embodiments. In addition to the nozzle activation being selective, the application of the spray composition may be controlled by extending or retracting the booms. The booms may be partially extended in some embodiments. The volume and pressure of the spray composition may be controlled through the nozzles. The concentration and type of active component in the spray composition may be controlled.

In one aspect, the vehicle control unit may include an image data analysis system that may automatically process the image data for identifying the first data content and the second data content. The vehicle control unit may automatically prevent and allow action by the vehicle responsive to the first data and the second data, respectively, that is identified by the image data analysis system. In one aspect, the system includes the transportation system receiver that may be located onboard the vehicle, where the transportation system receiver may communicate network data other than the image data at least one of onboard or off-board the vehicle and to automatically switch to a mode for receiving the image data from the portable unit responsive to the portable unit being active to communicate the image data. In one aspect, the system includes a retractable mast configured for attachment to a vehicle. The retractable mast may include one or more mast segments deployable from a first position relative to the vehicle to a second position relative to the vehicle. The second position is higher than the first position. The mast may include a coupler attached to one of the one or more mast segments for detachable coupling of the portable unit to said one of the one or more mast segments. The portable unit is coupled to the retractable mast by way of the coupler and the retractable mast is deployed to the second position, with the portable unit positioned above the vehicle.

In one embodiment, the vehicle is a marine vessel (not shown) and the portable system identifies marine equivalents to foliage. That is, a vessel may detect algal blooms, seaweed beds, oil slicks, and plastic debris, for example.

In one embodiment, a vehicle system with spray control is provided. The vehicle system includes a vehicle platform for a vehicle, a dispenser configured to dispense a composition onto at least a portion of an environmental feature adjacent to the vehicle, and a controller configured to operate one or more of the vehicle, the vehicle platform, or the dispenser based at least in part on environmental information.

The controller is configured to communicate with a position device and to actuate the dispenser based at least in part on position data obtained by the controller from the position device. The controller may include a spray condition data acquisition unit for acquiring spray condition data for spraying the composition comprising an herbicide from a storage tank to a spray range defined at least in part by the environmental feature adjacent to the vehicle. The dispenser may include a plurality of spray nozzles for spraying herbicides at different heights in a vertical direction.

The dispenser may include a variable angle spray nozzle capable of automatically adjusting a spraying angle of the composition. The environmental information may include one or more of a traveling speed of the vehicle or the vehicle platform, an operating condition of the dispenser, a contents level of dispenser tanks, a type of vegetation, a quantity of the vegetation, a terrain feature of a route section adjacent to the dispenser, an ambient humidity level, an ambient temperature level, a direction of travel of the vehicle, curve or grade information of a vehicle route, a direction of travel of wind adjacent to the vehicle, a windspeed of air adjacent to the vehicle, a distance of the vehicle from a determined protected location, and/or a distance of the vehicle from the vegetation.

The dispenser may include plural dispenser nozzles through which the composition is sprayed, and the controller may be configured to respond to the environmental information by switching operating modes with different ones of the operating modes selectively activating different nozzles of the dispenser nozzles. The dispenser may include plural dispenser nozzles organized into subsets. The subsets may be configured as one or more of: spraying one side of the vehicle, high spraying, low spraying, horizontal spraying, forward spraying, or rearward spraying. The dispenser may have adjustable nozzles that are configured to have selectively wide spray patterns and narrow streaming spray patterns.

The dispenser may have adjustable nozzles that are configured to be selectively pointed in determined directions. The controller may control a concentration of active chemicals within the composition being sprayed through the dispenser. The composition may be a mixture of multiple active chemicals, and the controller may be configured to control a mixture ratio of the multiple active chemicals. The controller may be configured to determine one or more of the mixture ratio or a concentration of the active chemicals in the composition in response to detection of one or more of a type of vegetation, a type of weed, a size of the weed, or a terrain feature.

The controller may be configured to selectively determine a concentration, a mixture, or both the concentration and the mixture of the composition based at least in part on a vehicle location relative to a sensitive zone. The dispenser may be configured to selectively add a foaming agent to the composition. The controller may be configured to control a pressure at which the dispenser dispenses the composition. The controller may be configured to select one or more nozzles of the dispenser or adjust an aim of the one or more nozzles.

The vehicle may be a high rail vehicle configured to selectively travel on a rail track and on a roadway. The vehicle may have maintenance equipment be mounted to the vehicle platform and configured to maintain a section of a route adjacent to the vehicle. The maintenance equipment implement may include one or more of an auger, a mower, a chainsaw or circular saw, an excavator scoop, a winch, and/or a hoist. The controller may communicate with sensors that determine a nature of vegetation adjacent to the route. The controller may communicate with sensors that determine whether a person is within a spray zone of the spray composition and to block the dispenser from spraying responsive to detecting a person within the spray zone. The controller may communicate with sensors that determine whether a person is within an area where operation of maintenance equipment mounted to the platform would injury the person.

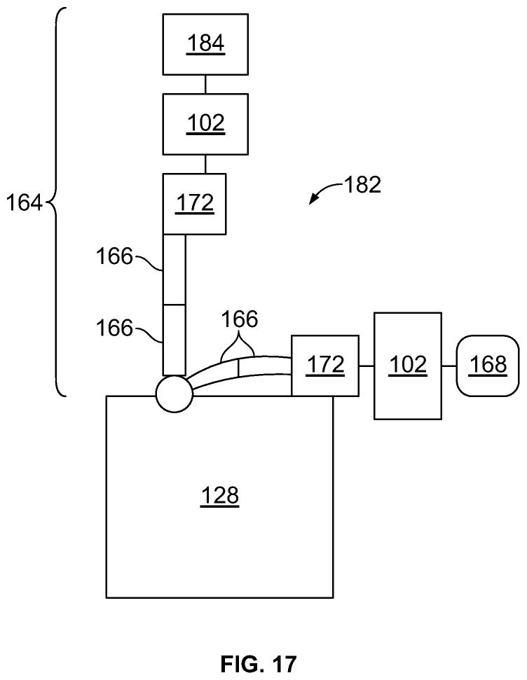

Referring to FIG. 17, a maintenance of way system 182 may include one or more controllable masts that may be attached to a vehicle. The retractable mast(s) may have one or more mast segments that support a maintenance equipment implement and a directed energy system 184 relative to the vehicle. The controllable mast(s) may include a coupler attached to at least one of the mast segments. The coupler allows for controlled movement and deployment of the maintenance equipment and/or the directed energy system. A portable unit may be coupled to the controllable mast.

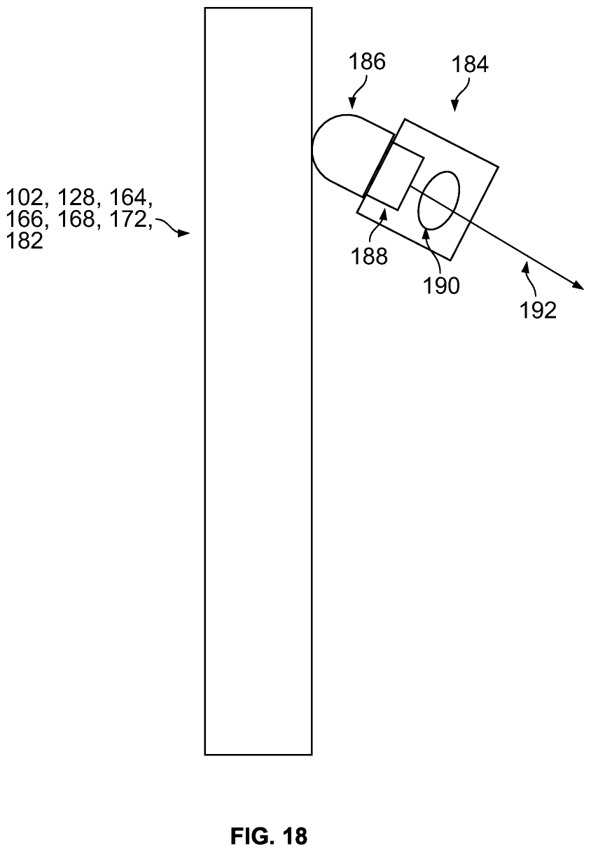

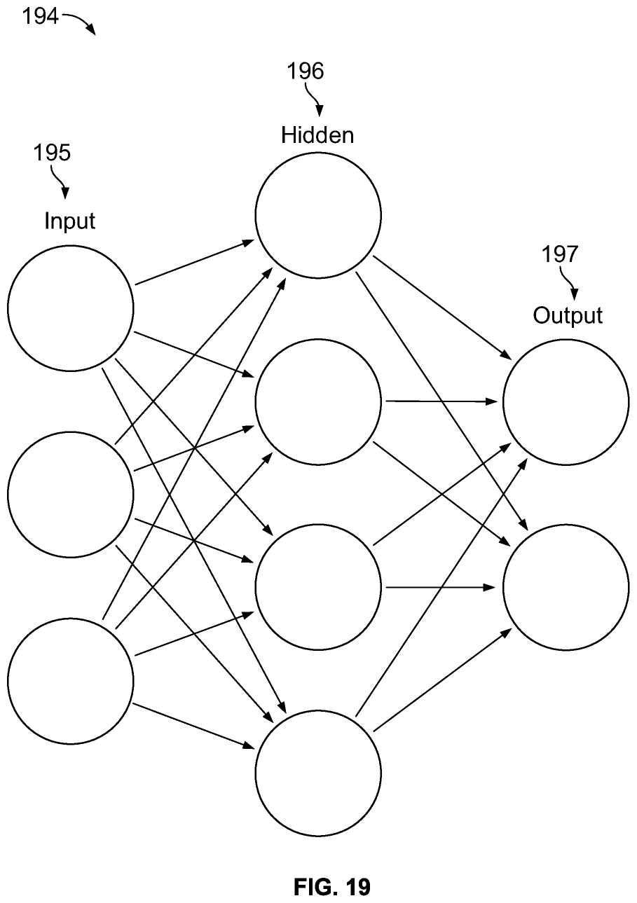

Referring to FIG. 18, the maintenance of way system may include a directed energy system 184 that is coupled to the vehicle system, for example the controllable mast, by a coupling 186. According to one embodiment, the coupling may be a pivot joint configured to allow the directed energy system to pivot and/or rotate so as to allow the directed energy system to direct a directed energy beam 192 to any location within the field of view of the portable unit that is adjacent to the vehicle. The directed energy system may be coupled to a mast segment or to a coupler of the controllable mast. The directed energy system may be coupled to a portable unit on the controllable mast. The directed energy system may include a directed energy source 188 configured to generate directed energy. The directed energy system may include a focusing assembly 190 configured to focus the directed energy generated by the directed energy source and project the directed energy beam.

According to one embodiment, the directed energy source may be a laser system. The laser system may be, for example, a CO₂ laser. The laser beam of the laser system may be continuous beam or a pulsed beam. The laser system may have a power of from 50 to 2000 W. For example, the laser system may have a power of 50 to 100 W, or from 200 to 500 W, or from 1,000 to 2,000 W.

According to one embodiment, the directed energy source may be a microwave energy source and the directed energy system may be a microwave amplification by stimulated emission of radiation (maser) system. According to one embodiment, the directed energy source may be a sonic energy source. According to one embodiment, the directed energy source may be a particle energy source, for example an electron or positron or ion source. According to one embodiment, the directed energy source may be a plasma source. The focusing and projecting assembly may focus the directed energy and project the directed energy beam at a determined power level for a determined time.

Referring to FIG. 19, a machine learning model 194 according to one embodiment may be provided in the form of a neural network. A neural network may be a series of algorithms that endeavors to recognize underlying relationships in a set of data. A “neuron” in a neural network is a mathematical function that collects and classifies information according to a specific architecture. The machine learning model may include an input layer 195, a hidden layer 196, and an output layer 197. The hidden layer is located between the input layer and the output layer of the algorithm of the machine learning model. The algorithm applies weights to the inputs (e.g., pressures and flows) and directs them through an activation function as the output. The hidden layer performs nonlinear transformations of the inputs entered into the network. According to one embodiment, the machine learning model may have two more hidden layers and be a deep learning model. The hidden layers may vary depending on the function of the machine learning model, and the hidden layers may vary depending on their associated weights. The hidden layers allow for the function of the machine learning model to be broken down into specific transformations of the input data. Each hidden layer function may be provided to produce a defined output. For example, one hidden layer may be used to identify objects within the field of view that are not vegetation. Another hidden layer may determine if image data within the field of view corresponds to vegetation. Other hidden layers may determine if image data corresponds to wayside equipment or people within the field of view.

The input layer may accept image data from one or more of the portable units. The image data may be obtained during operation of the vehicle system. According to one embodiment, the machine learning model may be an unsupervised machine learning model. According to one embodiment, the machine learning model may be a semi-supervised machine learning model. According to one embodiment, the machine learning model is a supervised machine learning model. The machine learning model may be provided with training data that is labelled. Data that represents vegetation that may be reduced or removed to maintain the way for the vehicle system may be labelled and provided to the machine learning model. The training data may also include vegetation that may be along the way of the vehicle system that is not to removed or reduced. The training data may also include image data of equipment that may be wayside of the vehicle system. The machine learning model may be trained not to direct any directed energy beams on the wayside equipment. The training data may also include image data of humans that may be in wayside locations of the vehicle system and the machine learning model may be trained not to direct energy beams toward humans. According to one embodiment, the vehicle system is a rail vehicle system and the training data may include image data of rust on rails. The directed energy system may use directed energy to remove rust on the rails identified by the machine learning model.

According to one embodiment, the machine learning model may be stored in a memory or data storage device and executed by the vehicle control system. According to one embodiment, the machine learning model may be executed by the image data analysis system of the vehicle control system.

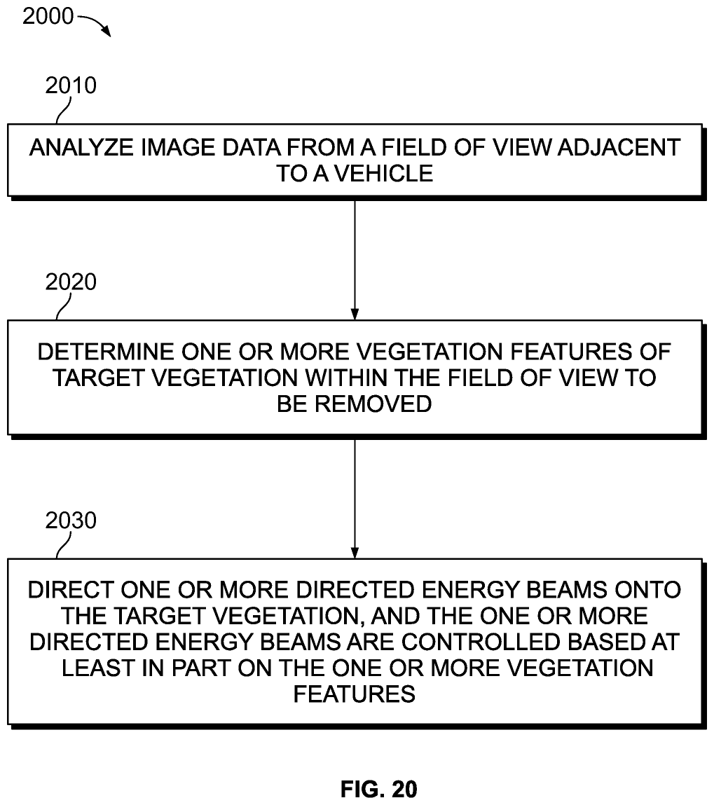

Referring to FIG. 20, a method 2000 may include a step 2010 of analyzing image data from a field of view adjacent to a vehicle and determining one or more vegetation features of target vegetation within the field of view to be removed. The method may include a step 2020 of determining one or more vegetation features of target vegetation within the field of view to be removed and a step 2030 of directing one or more directed energy beams onto the target vegetation. The one or more directed energy beams may be controlled based at least in part on the one or more vegetation features.

A system may include an imaging device to obtain image data from a field of view outside of a vehicle and a controller configured to analyze the image data and identify one or more vegetation features of a target vegetation within the field of view. The vegetation features may be one or more of a type of vegetation, a quantity of vegetation, a distance of or a size of vegetation. The system may include a directed energy system configured to direct one or more directed energy beams toward the target vegetation responsive to the controller identifying the one or more vegetation features.

The directed energy system may be a laser system that emits laser energy. The controller may control one or more of a power or a duration of the one or more directed energy beams to burn or irradiate a portion of the target vegetation. The portion of the target vegetation may be a patch of skin or bark or leaves of the target vegetation. The target vegetation may be one or more weeds. The controller may control the directed energy system to direct the one or more directed energy beams onto one or more meristems of the one or more weeds. The target vegetation may be one or more trees. The controller may control the directed energy system to direct the one or more directed energy beams onto bark of the one or more trees.

The controller may determine an amount of the target vegetation that are removed based at least in part on a distance of the directed energy system from the target vegetation. The vehicle may be a rail vehicle. The target may include rust on one or more of a rail that the rail vehicle travels on or wayside equipment. The controller may determine an amount of the target vegetation that is removed based at least in part on an amount of power of the directed energy beams directed onto the target vegetation. The controller may operate a machine learning model to analyze the image data and identify the one or more vegetation features within the field of view using the machine learning model. The controller may determine, based at least in part on the vegetation features, if the target vegetation should be irradiated by the directed energy system or not, and if so for how long and at what power level.

A method may include analyzing image data from a field of view adjacent to a vehicle and determining one or more vegetation features of target vegetation within the field of view to be removed. The method may include directing one or more directed energy beams onto the target vegetation. The one or more directed energy beams may be controlled based at least in part on the one or more vegetation features.

The method may include controlling the one or more directed energy beams to be in a power range that is defined at least in part by the one or more vegetation features, a calculated or measured distance between a source of the directed energy beams and the target vegetation, or both. The one or more vegetation features may include one or more of a type of vegetation, a quantity of vegetation, or a size of vegetation about the target vegetation. The method may include controlling one or more of a power or a duration of the one or more directed energy beams based at least in part on the vegetation features. The type of vegetation may include one or more weeds. The method may include controlling the directed energy system to direct the one or more directed energy beams onto one or more meristems of the one or more weeds. The type of vegetation may include one or more trees. The method may include controlling the directed energy system to direct the one or more directed energy beams onto bark of the one or more trees. The amount of bark to be removed, burned or irradiated by the directed energy beams may be determined based at least in part on the vegetation features. Some trees may be too thick or large to be cut down by the directed energy beams. Removing bark around the perimeter of the trees (e.g., girdling the trees) can kill and destroy the trees, thereby eventually removing the trees.

The method may include controlling an amount of the target vegetation to be affected based at least in part on an amount of power of the directed energy beams directed onto the target vegetation. The method may include operating a machine learning model to analyze the image data and determine the one or more vegetation features within the field of view.

A system may include one or more imaging devices onboard one or more vehicles that obtain image data from one or more fields of view adjacent to the one or more vehicles and one or more controllers in communication with the one or more imaging devices. The one or more controllers may analyze the image data and determine one or more vegetation features of target vegetation within the one or more fields of view. The system may include one or more directed energy systems onboard the one or more vehicles that generate and direct one or more energy beams onto the target generation in response to the controller analysis of the vegetation features.

The one or more controllers may include one or more directed energy data acquisition units configured to acquire directed energy data for directing the one or more directed energy beams. The one or more vegetation features may include one or more of a type of vegetation, a quantity of vegetation, or a size of vegetation to be removed. The one or more controllers may operate one or more machine learning models to analyze the image data and determine the one or more vegetation features.

In one embodiment, the control system may have a local data collection system deployed that may use machine learning to enable derivation-based learning outcomes. The controller may learn from and make decisions on a set of data (including data provided by the various portable units), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the control system may include a policy engine that may apply one or more policies. These policies may be based at least in part on characteristics of a given item of equipment or environment. With respect to control policies, a neural network may receive input of a number of environmental and task-related parameters. These parameters may include an identification of a determined trip plan for a vehicle group, data from various sensors, and location and/or position data. The neural network may be trained to generate an output based on these inputs, with the output representing an action or sequence of actions that the vehicle group should take to accomplish the trip plan. During operation of one embodiment, a determination may occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following clauses, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. Other embodiments will be apparent to one of ordinary skill in the art upon reviewing the above description. The scope of the subject matter should, therefore, be determined with reference to the appended claims, along with the full scope of equivalents to which such clauses are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system, comprising:
an imaging device configured to obtain image data from a field of view outside of a vehicle;
a controller configured to analyze the image data and identify one or more vegetation features of a target vegetation within the field of view, the one or more vegetation features including one or more of a type of vegetation, a quantity of vegetation, a distance to or a size of vegetation; and
a directed energy system configured to direct one or more directed energy beams toward the target vegetation responsive to the controller identifying the one or more vegetation features.

2. The system of claim 1, wherein the directed energy system is a laser system that emits laser energy, and the controller is configured to control one or more of a power or a duration of the one or more directed energy beams to burn or irradiate a portion of the target vegetation.

3. The system of claim 2, wherein the portion of the target vegetation is a patch of skin or bark, or leaves of the target vegetation.

4. The system of claim 3, wherein the target vegetation comprises one or more weeds, and the controller is configured to control the directed energy system to direct the one or more directed energy beams onto one or more meristems of the one or more weeds.

5. The system of claim 3, wherein the target vegetation comprises one or more trees, and the controller is configured to control the directed energy system to direct the one or more directed energy beams onto bark of the one or more trees.

6. The system of claim 1, wherein the controller is configured to determine an amount of the target vegetation that are removed based at least in part on a distance of the directed energy system from the target vegetation.

7. The system of claim 1, wherein the controller is configured to determine an amount of the target vegetation that are removed based at least in part on an amount of power of the directed energy beams directed onto the target vegetation.

8. The system of claim 1, wherein the controller is configured to operate a machine learning model to analyze the image data and identify the one or more vegetation features within the field of view using the machine learning model, and to determine whether the target vegetation should be irradiated by the directed energy system and a duration that the target vegetation should be irradiated by the directed energy system based at least in part on one or more vegetation features.

9. A method, comprising:
analyzing image data from a field of view adjacent to a vehicle;
determining one or more vegetation features of target vegetation within the field of view to be removed; and
directing one or more directed energy beams onto the target vegetation, and the one or more directed energy beams are controlled based at least in part on the one or more vegetation features.

10. The method of claim 9, further comprising controlling the one or more directed energy beams to be in a power range that is defined at least in part by (a) the one or more vegetation features, (b) a distance between a source of the directed energy beams and the target vegetation, or (c) both the one or more vegetation features and the distance.

11. The method of claim 9, wherein the one or more vegetation features include one or more of a type of vegetation, a quantity of vegetation, or a size of vegetation about the target vegetation, and the method further comprises:
controlling one or more of a power or a duration of the one or more directed energy beams based at least in part on the one or more vegetation features.

12. The method of claim 11, wherein the type of vegetation comprises one or more weeds, and the method further comprises controlling the directed energy system to direct the one or more directed energy beams onto one or more meristems of the one or more weeds.

13. The method of claim 11, wherein the type of vegetation comprises one or more trees, and the method further comprises controlling the directed energy system to direct the one or more directed energy beams onto bark of the one or more trees.

14. The method of claim 13, wherein the amount of bark to be removed, burned or irradiated by the directed energy beams is determined based at least in part on the one or more vegetation features.

15. The method of claim 9, further comprising controlling an amount of the target vegetation to be affected based at least in part on an amount of power of the directed energy beams directed onto the target vegetation.

16. The method of claim 9, further comprising operating a machine learning model to analyze the image data and determine the one or more vegetation features within the field of view.

17. A system, comprising:
one or more imaging devices onboard one or more vehicles that are configured to obtain image data from one or more fields of view adjacent to the one or more vehicles;
one or more controllers in communication with the one or more imaging devices that are configured to analyze the image data and determine one or more vegetation features of target vegetation within the one or more fields of view; and
one or more directed energy systems onboard the one or more vehicles that are configured to generate and direct one or more energy beams onto the target generation in response to the controller analysis of the one or more vegetation features.

18. The system of claim 17, wherein the one or more controllers are configured to acquire directed energy data for directing the one or more directed energy beams.

19. The system of claim 17, wherein the one or more vegetation features include one or more of a type of vegetation, a distance of vegetation, a quantity of vegetation, or a size of vegetation to be removed.

20. The system of claim 17, wherein the one or more controllers are configured to operate one or more machine learning models to analyze the image data and determine the one or more vegetation features.
